(19) United States
(12) Patent Application Publication
(10) Pub. No.: US 2004/0031448 A1
(43) Pub. Date: Feb. 19, 2004

(54) Post-surgical care bandage cover for pets

(76) Inventor: Diana M. Trepanier, Sidney, ME (US)

Correspondence Address: Richard C. Litman, LITMAN LAW OFFICES, LTD., P.O. Box 15035, Arlington, VA, 22215, US

(21) Appl. No.: 10/619,586

(22) Filed: Jul. 16, 2003

Related U.S. Application Data
(60) Provisional application No. 60/402,729, filed on Aug. 13, 2002.

(51) Int. Cl. A01K 13/00

(52) U.S. Cl. 119/850

(57) ABSTRACT

A bandage cover is a vest-type body sock which prevents an animal from disturbing a gauze bandage or wound, aggravating post surgery wounds. The bandage cover fits over the head, neck, and front trunk of the animal and openings provided for the head, front legs, and rear trunk past the chest. The bandage cover is preferably made of spandex polyester fabric so as to fit snugly around the body of the animal. The bandage cover has a single seam running down the neck, chest and trunk sections of the bandage. Hems surround the openings. An elastic band is preferably sewn into a bunched portion of the rolled hem of the rear opening of the vest extending downward, about three-quarters around of the trunk and belly of the animal preventing it from pulling the vest forward. A reversible version covers a wound from removal of a front leg.

### CROSS-REFERENCE TO RELATED APPLICATION

This application claims the benefit of U.S. Provisional Patent Application Serial No. 60/402,729, filed Aug. 13, 2002.

### BACKGROUND OF THE INVENTION

1. Field of the Invention

The present invention relates to bandage covers for pets. More particularly, the present invention is a bandage cover in the form of a vest-type body sock which prevents an animal from disturbing the gauze bandage and thus aggravating post surgery wounds.

2. Description of Related Art

Surgery or repair of a wound to an animal such as a dog or cat is commonly practiced on a pet. In some cases a front leg must be removed, such as when the pet suffers from multiple melanoma cancer. A gauze bandage is commonly applied over wounds to promote healing. Pets, however, are naturally inclined to lick the wound and attempt to remove foreign materials such as gauze dressings. In some cases, the wound is not covered by gauze, however it would be desirable to provide a cover which can protect against disturbance or removal by the pet or to keep the pet from licking the wound, while allowing air flow to the wound to promote the healing process.

It would be desirable, to provide a cover for a pet which is easily mounted and removed and which can effectively cover a dressed or undressed wound, protecting the area from constant washing, and keeping the wound clean, allowing air flow but excluding dust and dirt. It would also be desirable to provide such a cover which provides easy access to the wound for inspection by a veterinarian without entirely removing the cover, a task which may be laborious and time consuming, depending on the size and disposition of the pet, while assuring that the pet cannot remove the cover for access to the wound. It would also be desirable to provide a cover which is durable, machine washable, stylish, amenable to decoration, available in a variety of colors and sizes while remaining affordable for any dog owner.

Such a cover would be attractive in appearance as opposed to an open wound and a cone-shaped collar as presently used. The cover would preferably be made of a stretch-type elastic fabric, the size of cover being in part determined by the desire to have a loose fit or a form fit, depending on preference and the breed of dog. The cover would preferably be useful and attractive even when not serving as a wound cover, such as for keeping a dog warm during walks. The stretch-type material would be sewn together and around borders with elastic stretch stitch to allow ease in mounting the cover on the pet, providing a close fit around legs and neck. The stretch-material design allows for the cover to remain on the animal without attachment to hind legs or tail.

It is preferred that the cover extend in the manner of a vest-type body sock, beginning at the upper neck of the pet and terminating at a point to the rear of the pet's ribs and constructed so as to be resistant to removal by the animal while being easily rolled up forward for inspection of the wound. It would also be desirable to provide a cover with only one leg hole in cases where the other leg has been removed, leaving an open wound. It is also preferred that a stretchable vest-type configuration be used which allows a single size vest to fit a range of pet sizes, minimizing the number of sizes required to keep in inventory by a merchant or veterinarian.

U.S. Pat. No. 6,267,083 B1, issued Jul. 31, 2001, to P. Chimienti describes an animal support bandage specifically designed to keep a dog such as a dachshund's back aligned and to minimize pressure on the back. The garment comprises a flexible body wrap with removable longitudinal support battens disposed in receiver pockets disposed on the dog's back. Openings are supplied for the neck and front legs of the animal.

U.S. Pat. No. 4,355,600, issued Oct. 26, 1982, to G. J. Zielinski, describes a protective suit for animals that holds a bandage against an animal and prevents the animal from licking a wound. The suit comprises a tube of elastic fabric with holes for the animal's head and legs.

U.S. Pat. No. 3,8895,628, issued Jul. 22, 1975, to G. A. Adar, describes a body-encompassing bandage protector for dogs and other animals. The device covers and protects a bandage applied to the animal's body.

U.S. Pat. No. 5,996,537, issued Dec. 7, 1999, to S. B. Caditz, describes an adjustable canine coat having chest section which attaches to a coat portion along the dog's side.

U.S. Pat. No. 6,119,635, issued Sep. 19, 2000, to K. Powell-Lesnick, describes a protective cover for placement over the back of an animal such as a dog to prevent the animal from removing a medicament placed on its back, prevents the animal from chewing or biting the area, and prevents sunburn.

Internet Catalogue of K9 Top Coat, Talent, Oregon describes a safety vest for dogs of bright colored Lycra stretch material is described which is useful in identifying hunting dogs in the field, but is loosely fitted allowing access by the dog to a wound and thus is not effective as a wound cover.

Internet Catalogue of K9 Top Coat, Talent, Oregon describes a Lycra full body suit for a dog which is useful for covering wounds. This full body suit would necessarily require a zipper or other fitting device, would be difficult to place on a pet, requires a large number of sizes to be available to fit a variety of pets, and would not necessarily allow easy access to the wound by a veterinarian.

None of the above inventions and patents, taken either singly or in combination, is seen to describe the instant invention as claimed.

### SUMMARY OF THE INVENTION

The present invention is a bandage cover in the form of a vest-type body sock which prevents an animal from disturbing the gauze bandage and thus aggravating post surgery wounds. The bandage cover may also act as a protective bandage where no gauze bandage is needed. The bandage cover fits over the head and neck of the animal and apertures are provided for the front legs. The bandage cover in the preferred form extends around the pet body to a rear opening at a point past the chest. The bandage cover is preferably made of spandex polyester fabric so as to fit snugly around the body of the animal. The bandage cover has a single seam running down the neck, chest, and trunk sections of the bandage, as well as sewn hems surrounding all openings. Stitching may be elastic top-stitched to allow for a snug fit on the animal. An elastic band is preferably sewn into a bunched portion of the rolled hem of the rear opening of the vest extending downward, about three-quarters around of the trunk of the animal including its belly to allow for snug fit which prevents the animal from pulling the vest forward. A reversible embodiment is provided with only one front leg aperture so as to cover the wound from the removal of the other front leg.

Accordingly, it is a principal object of the invention to provide a bandage cover to be worn by a pet which protects the gauze bandage or open wound from being disturbed by the animal such as by licking or biting.

It is another object of the invention to provide a wound or bandage cover as above to be worn by a pet which provides for free flow of air to the wound while excluding dust and dirt.

It is another object of the invention to provide a wound or bandage cover as above to be worn by a pet which is of elastic material for close fit around the pet's head and legs to prevent the animal from reaching a wound by pulling back the cover by paws, mouth, or rubbing against a fixed article.

It is a further object of the invention to provide a wound or bandage cover as above which is in the form of a vest type body sock, extending from the upper neck opening to a rear trunk opening at a point to the rear of the rib cage for secure fit while being subject to being rolled up forward for inspection of the wound without removal of the garment.

It is another object of the invention to provide a wound or bandage cover as above which fits sufficiently tightly around the rear body opening, preventing pulling forward by the pet to expose the wound.

It is yet another object of the invention to provide a wound or bandage cover as above which presents and attractive appearance to a wounded pet.

Still another object of the invention is to provide a wound or bandage cover as above which is provided with only one front leg opening so as to cover the wound left by removal of the other front leg.

It is yet another object of the invention to provide a bandage cover useful for use as a garment for keeping a dog warm during a walk.

It is still another object of the invention to provide a bandage cover as above which is available in various sizes and colors and is amenable to decoration.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a post-surgical care bandage cover for pets according to the present invention.

FIG. 2 is a side view of the bandage cover of FIG. 1 as laid flat.

FIG. 3 is a plan view of the bandage cover of FIG. 2 with seam opened and cover laid flat.

FIG. 4 is an environmental perspective view of a bandage cover as worn by a dog after front leg is removed.

FIG. 5 is a side view of the bandage cover of FIG. 4 as laid flat with the single leg opening in view.

FIG. 6 is a plan view of the bandage cover of FIG. 4 with the seam opened and the cover laid flat.

FIG. 7 is an environmental top view of the bandage cover of FIG. 4 as worn by pet dog.

Similar reference characters denote corresponding features consistently throughout the attached drawings.

### DETAILED DESCRIPTION OF THE PREFERRED EMBODIMENTS

The present invention is a bandage cover for a pet in the form of a body sock having openings for the head and front legs of the pet.

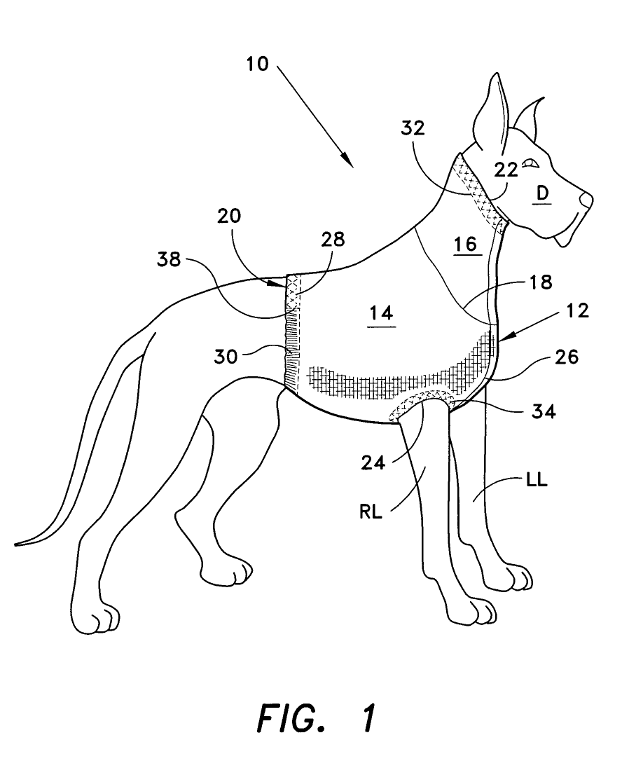

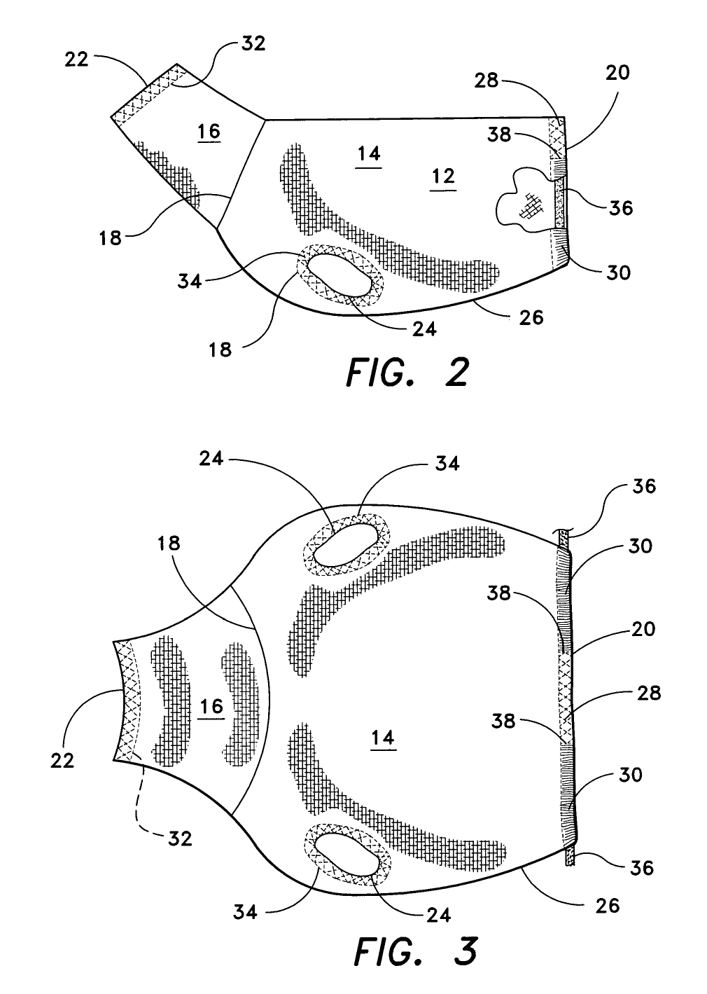

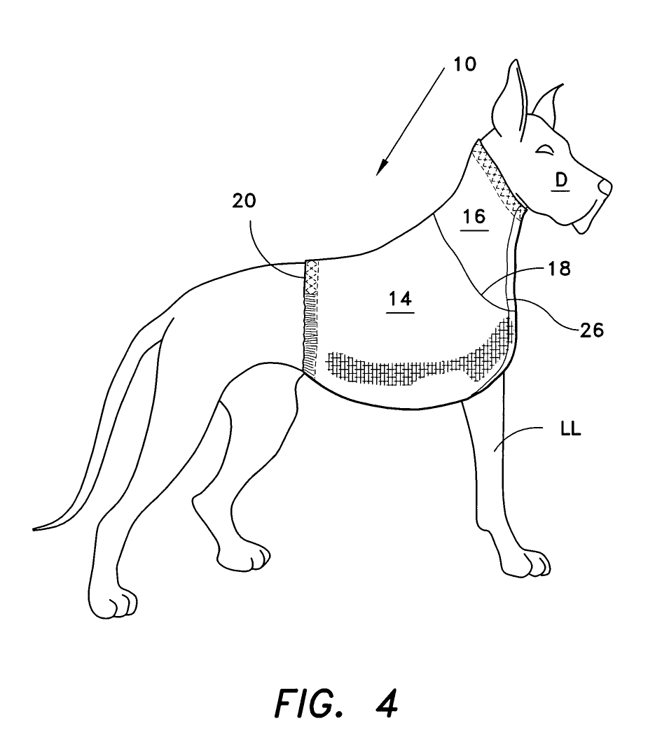

Referring to FIGS. 1-3, wound cover system 10 in the form of vest-like body sock 12 is worn by dog D. Vest-like body sock 12 has a trunk cover 14 and a neck cover 16 sewn together by seam 18. Trunk cover 14 has a rear opening 20 in the vicinity of rear of the rib cage of dog D. The rear opening 20 is substantially perpendicular to the trunk of the dog D. Trunk cover 14 extends to the front of the chest of the dog D and has two lower front leg openings 24 for receiving left front leg LL and right front leg RL of dog D. Neck cover 16 extends upward from trunk cover 14, ending in neck opening 22 at the upper portion of the neck of dog D. The bandage or wound cover system 10 is made of a stretchable material so as to smoothly fit the neck, front trunk, and chest of dog D.

The periphery of rear opening 20, neck opening 22, and leg openings 24 are each folded over to form respective hems 28, 32, and 34, respectively and sewn with a cross elastic cross stitch so as to snugly fit around the body features of dog D. Rear opening hem 28 has an upper cross stitched portion and a lower bunched portion 30 having an elastic band 36 sewn therein to provide additional elasticity at opening 20. Bunched portion 30 containing elastic band 36 reaches between upper sides and around the belly of dog D and the band at each end thereof is securely tacked to hem 28 at tacking points 38, the bunched portion 30 being straight stitched to the elastic band 36. This configuration provides the desired comfort for the pet and needed security at rear opening 20.

The vest-like body sock 12 is preferably sewn together by chest and neck seam 34 reaching from the neck opening 22 at a point under the chin to the rear opening 20 at the belly of the dog D, although the seam may be made elsewhere as desired. The elastic band is an integral strip, extending through the bunched hem at seam 34. Each of seams 18 and 34 may be of conventional stitching or cross elastic cross stitching as desired. The vest-like body sock 12 may be sewn to match the general shape of the trunk of the pet, being expanded in the rib cage area as needed.

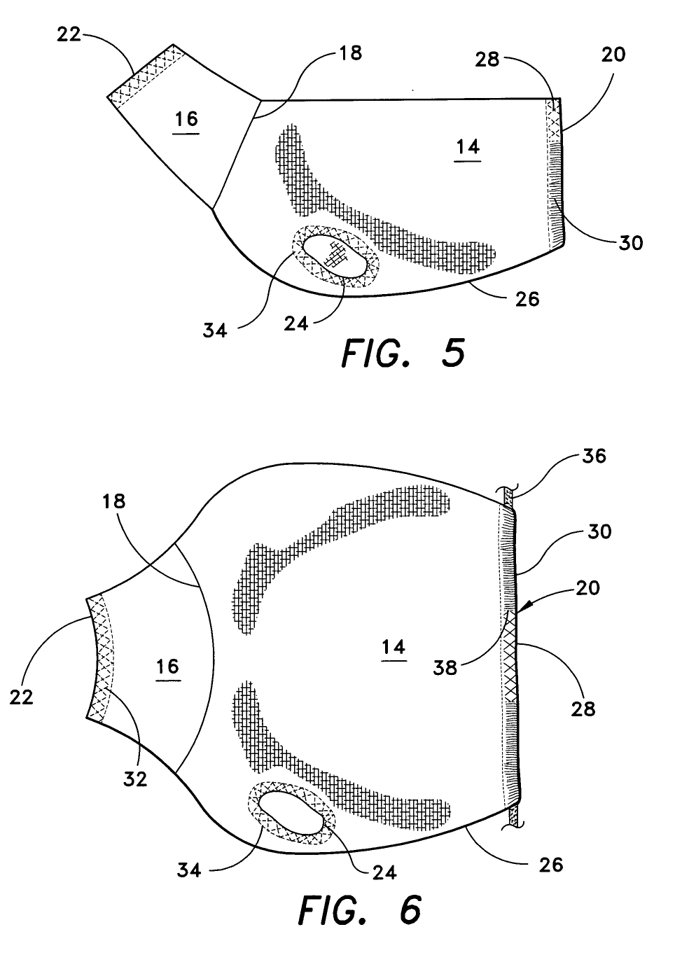

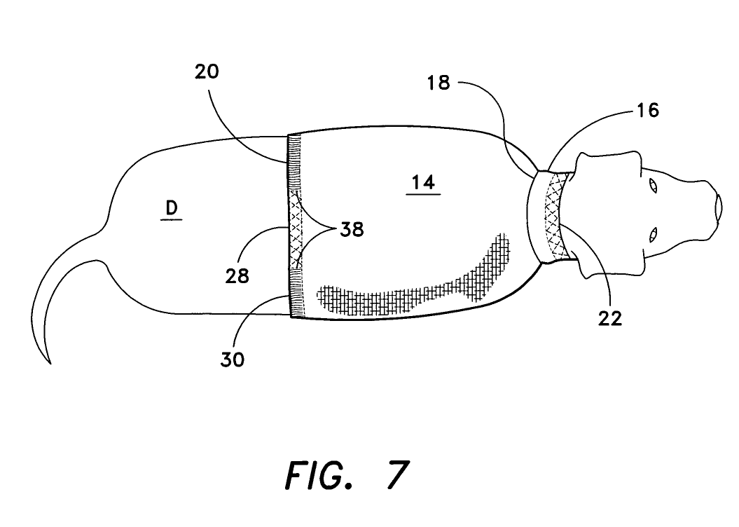

Referring to FIGS. 4-7, another embodiment of wound cover system 10 is a vest-like body sock 12 worn by dog D for a dog with a front right leg removed. The vest-like body sock 12 is identical to that of FIGS. 1-3, having a trunk cover 14 and a neck cover 16 sewn together by seam 18. Trunk cover 14 has a rear opening 20 in the vicinity of rear of the rib cage of dog D. The rear opening 20 is substantially perpendicular to the trunk of the dog D.

Trunk cover 14 extends to the front of the chest of the dog D and has a lower left front leg opening 24 for receiving left front leg LL. Neck cover 16 extends upward from trunk cover 14, ending in neck opening 22 at the upper portion of the neck of dog D. In this embodiment the dog D has had the right leg RL removed and body sock 12 has only one lower front opening 24 to accommodate the left leg LL, the material of the body sock covering the wound from exposure to the outside. This improves the appearance of the animal and provides cover for the wound or bandaged wound resulting from the removal of the leg. This embodiment of wound cover system 10 may be made reversible so as to fit both a right front leg amputee and a left front leg amputee.

The material for the inventive wound cover system 10 is preferably of an elastic, stretchable cloth such as a polyester blended with one of Lycra, or spandex but may include Rayon, or cotton, the cloth preferably being of an open weave so as to allow free flow of air therethrough while excluding dust or dirt. The wound cover system 10 may be reversible with different colors on the inner or outer side.

The inventive wound cover system may be of any desired size and relative dimension so as to fit a particular size and breed of dog or other pet.

It is to be understood that the present invention is not limited to the embodiments described above, but encompasses any and all embodiments within the scope of the following claims.

I claim:

1. A post-surgical care wound and bandage cover for a pet such as a dog, comprising:
a vest-like trunk cover having a front upper opening and a rear opening, said trunk cover extending from the chest front to a point in the vicinity of the rear of the rib cage of the pet; and
a neck cover defining an upper opening and a lower opening, said neck cover extending downward from the upper neck to said front upper opening of said trunk cover and communicating therewith;
said vest-like trunk cover defining at least one lower front opening of such size as to receive a corresponding front leg of the pet;
said trunk cover and said neck cover being connected so as to form a vest-like body sock for placement over the front portion of the body of a pet;
whereby said vest-like body sock covers an exposed or gauze-dressed wound.

2. The cover of claim 1, wherein said vest-like trunk cover defines two lower front openings of such size and location as to receive left and right front legs of the pet.

3. The cover of claim 1, wherein said vest-like body sock is made of an elastic material so as to snugly fit the body of the pet.

4. The cover of claim 1, wherein said neck cover and said trunk cover are connected by a seam.

5. The cover of claim 4, wherein said seam is an expandable cross stitch seam.

6. The cover of claim 1, wherein said neck cover opening is of such size as to snugly fit around the upper neck of the pet, and said neck cover opening has an expandable cross stitch hem.

7. The cover of claim 1, wherein each said leg opening in said trunk cover has an expandable cross stitch hem.

8. The cover of claim 1, wherein said rear opening of said trunk portion has an expandable cross stitch hem.

9. The cover of claim 8, wherein said hem includes a bunched portion extending around the belly of the pet, said trunk portion having an integral elastic strip, said integral elastic strip being straight sewn within said hem bunched portion.

10. The cover of claim 9, wherein said integral elastic strip is straight sewn within said hem.

11. The cover of claim 1, wherein there is a single lower front opening and said cover is reversible, so as to cover a wound from the removal of a front leg of the pet.

12. The cover of claim 11, wherein said elastic material is spandex or Lycra having polyethylene mixed therewith and is open weaved such as to allow passage of air to the wound while excluding dust and dirt.

13. The cover of claim 1, wherein said cover is made of cotton or Nylon and is open weaved such as to allow breathing of air to the wound.

14. A post-surgical care wound and bandage cover for a pet such as a dog, comprising:
a vest-like trunk cover having a front upper opening and a rear opening, said trunk cover extending from the chest front to a point in the vicinity of the rear of the rib cage of the pet; and
a neck cover defining an upper opening and a lower opening, said neck cover extending downward from the upper neck to said front upper opening of said trunk cover and communicating therewith;
said vest-like trunk cover defining at least one lower front opening of such size as to receive a corresponding front leg of the pet;
said trunk cover and said neck cover being connected by a an expandable cross stitched seam so as to form a vest-like body sock for placement over the front portion of the body of a pet;
said rear opening of said trunk portion having an expandable hem which includes an upper cross stitched portion and a bunched portion extending around the trunk and belly of the pet, said bunched portion containing an elastic strip;
said cover being made of open weave breathable material such as to allow passage of air to the wound while excluding dust and dirt;
whereby said vest-like body sock covers an exposed or gauze-dressed wound.

15. The cover of claim 14, wherein said integral elastic strip is straight sewn within said hem.

16. The cover of claim 15, wherein there is a single lower front opening and said cover is reversible, so as to cover a wound from the removal of a front leg of the pet.

17. The cover of claim 15, wherein said cover is made of elastic material and the elastic material is spandex or Lycra having polyethylene mixed therewith.

18. The cover of claim 15, wherein said cover is made of cotton or Nylon.

19. The cover of claim 17, wherein said cover is so configured and constructed as to allow a veterinarian to roll or peel back a portion of said cover to expose the wound.

20. The cover of claim 19, wherein said cover is so sized and configured relative to the pet as to allow ease in placing the cover on the pet and removing same, while the pet cannot remove the cover from the wounded area by means of mouth, paws, or rubbing against an object.
